(19) United States
(12) Patent Application Publication
(10) Pub. No.: US 2022/0067861 A1
(43) Pub. Date: Mar. 3, 2022

(54) CONTACT/INFORMATION SHARING ASSISTANCE SYSTEM FOR SCHOOL

(71) Applicant: 137. inc, MlNATO-KU, TOKYO (JP)

(72) Inventor: Chika KURODA, MINATO-KU, TOKYO (JP)

(21) Appl. No.: 17/414,076

(22) PCT Filed: Dec. 16, 2019
(86) PCT No.: PCT/JP2019/049240

§ 371 Date: Jun. 15, 2021

(30) Foreign Application Priority Data
Dec. 19, 2018 (JP) 2018-236965

(51) Int. Cl. G06Q 50/20

(52) U.S. Cl. CPC G06Q 50/205

(57) ABSTRACT

A management system S is provided with a contact information determination unit 4k for determining contact information for a parent in response to a request from a school teacher or the parent, and a cultural understanding degree recognition unit 4f for recognizing a cultural understanding degree that indicates a degree of understanding of a parent P with respect to a culture in a location of a school, based on at least one of pupil/student information that is information on a pupil/student and parent information that is information on the parent P of the pupil/student. The contact information determination unit 4k changes a content of the contact information in accordance with the recognized cultural understanding degree.

### TECHNICAL FIELD

The present invention relates to a contact/information sharing assistance system for school to assist contact and information sharing between staff of a school such as a teacher (hereinafter referred to as a school teacher) and each parent of a plurality of pupils/students attending the school.

### BACKGROUND ART

Conventionally, a contact assistance system for simultaneously sending a message to a multitude of registrants is known. As this type of contact assistance system, there is a system that converts a distribution format in accordance with a distribution route of information to a registrant and the like (see, for example, Patent Literature 1).

Then, the contact system as described in Patent Literature 1 is a system that can also be used when a school simultaneously makes contact with each parent of a plurality of pupils/students.

### CITATION LIST

### Patent Literature

Patent Literature 1: Japanese Patent Laid-Open No. 2011-232976

### SUMMARY OF INVENTION

### Technical Problem

Amid work style reform of school teachers being called for, the workload of school teachers is on the rise partly because the number of foreign pupils/students is increasing, which involves contact and information sharing with pupils/students and/or their parents in need of special assistance in accordance with their respective languages, a confirmation and aggregation work thereof, and the like.

For example, in a family of a foreign student, even his or her parent may not always have a sufficient mastery of the Japanese language. In such a case, even if the contact assistance system as described in Patent Literature 1 is used to make contact by converting the distribution format in accordance with the distribution route and the like, there is a problem in that the parent does not fully understand the content of the contact.

The present invention has been made in view of the above problem, and intends to provide a contact/information sharing assistance system for school that makes it easier for a parent to understand the content of contact or the content of information to be shared even when the parent does not have a sufficient mastery of the language primarily used in the school.

### Solution to Problem

A contact/information sharing assistance system for school of the present invention is a contact/information sharing assistance system for school for assisting contact and information sharing between a school teacher who is a member of staff of a school and each parent of a plurality of pupils/students attending the school, including a contact information determination unit for determining contact information that is information to be communicated to the parent in response to a request from the school teacher or the parent, and a cultural understanding degree recognition unit for recognizing a cultural understanding degree that indicates a degree of understanding of the parent with respect to a culture in a location of the school, based on at least one of pupil/student information that is information on the pupil/student and parent information that is information on the parent of the pupil/student, in which the contact information determination unit changes a content of the contact information in accordance with the recognized cultural understanding degree.

As described above, in the contact/information sharing assistance system for school of the present invention, the content of the contact information to be transmitted to the parent is changed in accordance with the cultural understanding degree of the parent. As a result, even when the parent who is a contact destination has a low cultural understanding degree (for example, when the parent does not have a sufficient mastery of the language primarily used in the school), the parent can fully understand the content of the contact information (that is, the content of the contact).

In addition, the contact/information sharing assistance system for school of the present invention is provided with a set language storage unit for storing a set language that is a language set for each of the parent, in which the cultural understanding degree recognition unit preferably recognizes the cultural understanding degree by referring to at least one of the set language, a country or a region before moving in a country or a region where the school is located, a date of moving in and/or out of the country or the region where the school is located, and a period of residence in the country or the region where the school is located.

The set language has a significant influence on the cultural understanding degree of the parent. For example, when the school is located in Japan, it can be estimated that a parent who speaks Japanese, English, or the like has a high cultural understanding degree. Therefore, as described above, if the cultural understanding degree is recognized by referring to the set language and the like, the content of the contact information can be determined more appropriately.

In addition, the contact/information sharing assistance system for school of the present invention is provided with an output format determination unit for determining an output format of the contact information at a time of contact with the parent, in which the output format determination unit preferably determines the output format by referring to the cultural understanding degree.

In this regard, the “output format” includes not only the type of data used for contact (for example, whether it is voice data or text data), but also the timing (time) and the frequency of contact.

In some cases, for example, it may be better to make contact with a parent having a low cultural understanding degree in an output format different from that for a parent having a high cultural understanding degree. In other cases, for example, it may be better to add relevant information such as the URL of a web site for additional explanation of the contact information, increase a frequency of notification, or make contact in a format including information on where to refer for an image or an explainer video. Therefore, as described above, if the system is configured such that the output format is determined in accordance with the cultural understanding degree, it is possible to notify the parent of the content of contact information in a more appropriate manner.

In addition, in the contact/information sharing assistance system for school of the present invention, the contact information determination unit preferably causes the contact information to include item image data that is image data of an item to be used in an event held by the school, in accordance with the cultural understanding degree of the parent.

In this regard, the “item image data” includes not only data of the image of the item itself, but also data of the URL of a web site of the image or the explainer video of the item.

Some parents may not even have a sufficient mastery of the set language, and thus may not even be able to understand the item itself to be used in an event held by the school. Therefore, as described above, if the item image data is included in the contact information, the parent can fully understand the content of the contact information if the parent does not have a sufficient mastery of the set language.

However, depending on the cultural understanding degree, the item image data may not be necessary, and for some parents, it may be easier to understand the content of the contact without the item image data. Therefore, as described above, if the system is configured such that whether or not the item image data is included in the contact information is determined in accordance with the cultural understanding degree of the parent, it becomes further easier for the parent to understand the content of the contact information.

In addition, in the contact/information sharing assistance system for school of the present invention, the contact information determination unit preferably causes the contact information to include item preparation information that is information for preparing an item to be used in an event held by the school, in accordance with the cultural understanding degree of the parent.

Some parents may not know how to prepare an item to be used in an event held by the school even if they are able to understand the item itself. Therefore, as described above, if the item preparation information (for example, information on a store or the like that sells the item, the price of the item, and the like) is included in the item information, the parent can easily prepare the item.

However, depending on the cultural understanding degree, the item preparation information may not be necessary, and for some parents, it may be easier to understand the content of the contact without the item preparation information. Therefore, as described above, if the system is configured such that whether or not the item preparation information is included in the contact information is determined in accordance with the cultural understanding degree of the protector, it becomes further easier for the parent to understand the content of the contact information.

### BRIEF DESCRIPTION OF DRAWINGS

FIG. 1 is an explanatory diagram showing a schematic structure of the management system according to an embodiment.

FIG. 2 is a block diagram showing a structure of processing units relating to the contact of the management system of FIG. 1.

FIG. 3 is a block diagram showing a structure of processing units relating to the absence of the management system of FIG. 1.

FIG. 4 is a flowchart showing the processing executed when contact is made between a parent and a school teacher by using the management system of FIG. 1.

FIG. 5 is a flowchart showing the processing executed when a status of a pupil/student is grasped by using the management system of FIG. 1.

FIG. 6 is an image diagram showing an example of an image that shows a school-wide absence status in a given day displayed on the school-side terminal of the management system of FIG. 1.

FIG. 7 is an image diagram showing an example of an image that shows an absence status of a class in a given day displayed on the school-side terminal of the management system of FIG. 1.

FIG. 8 is an image diagram showing an example of an image that shows detailed information on an absence of a student displayed on the school-side terminal of the management system of FIG. 1.

FIG. 9 is an image diagram showing an example of an image that shows an absence status in a given month displayed on the school-side terminal of the management system of FIG. 1.

### DESCRIPTION OF EMBODIMENTS

Hereinafter, a structure of a management system S (contact/information sharing assistance system for school) according to the embodiment will be described with reference to the drawings.

It should be noted that the present management system S has a function of assisting contact from a parent of a pupil to a school teacher and contact from the school teacher to the parent at an elementary school.

In addition to the function of assisting the above-described contact, the present management system S also has a function of assisting a work related to student guidance for a pupil/student attending the school, a care or assistance work related to health management therefor, and a work related to class management based on the student guidance and the health management (hereinafter, these works are collectively referred to as “student guidance work”).

In this regard, the “student guidance” refers to the guidance given in order to enhance a social quality and an ability to act of each pupil/student while respecting his or her personality and aiming to develop his or her individuality. The student guidance is considered to be one of the important functions for a school to achieve its educational objectives.

An example of the work related to the student guidance includes a work such as guidance on matters related to school life (for example, matters related to learning and school life environments, physical and/or mental health problems, and health management).

It should be noted that the contact/information sharing assistance system for school of the present invention is not limited to such a structure, and may have only the function of assisting contact from a parent of a pupil/student to a school teacher or contact from the school teacher to the parent. In addition, the contact/information sharing assistance system for school of the present invention can be applied not only to elementary schools, but also to other educational institutions (schools) such as kindergartens, nursery schools, middle schools, high schools, universities, and vocational schools as long as they are educational institutions in which contact between a parent of a pupil/student and a school teacher is necessary.

In addition, the management system S is configured to assist contact in a school in which Japanese is primarily used, not only when contact is made with a parent who speaks Japanese but also when contact is made with a parent who speaks a language other than Japanese.

However, the contact/information sharing assistance system for school of the present invention is not limited to such a structure, and can be applied when the language primarily used in a school and the language used by a parent are different. Therefore, the language primarily used in the school may be other than Japanese.

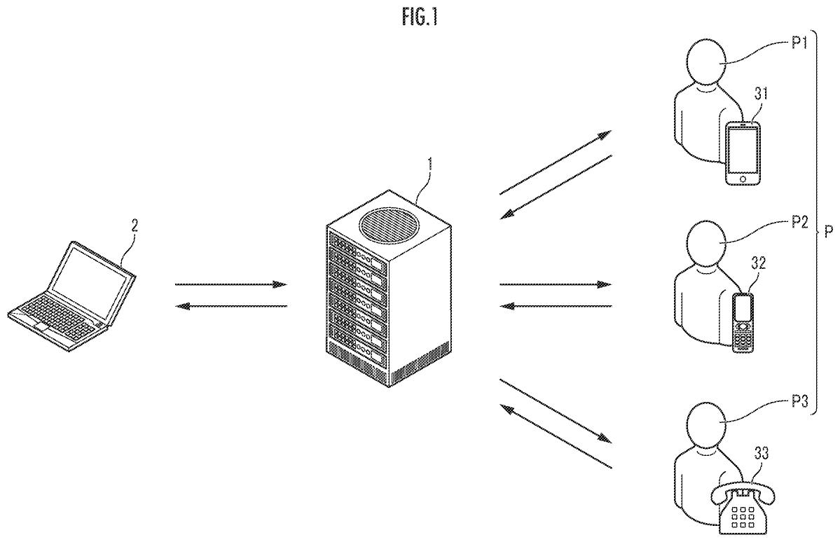

First, the schematic structure of the management system S will be described with reference to FIG. 1.

As shown in FIG. 1, the management system S is provided with a server 1 owned by a provider of service by the management system S, a school-side terminal 2 such as a personal computer used by a school teacher in a school, a first parent-side terminal 31, a second parent-side terminal 32, and a third parent-side terminal 33 (hereinafter, collectively referred to as “parent-side terminals 3”) used by each of a first parent P1, a second parent P2, and a third parent P3 (hereinafter, collectively referred to as “parents P”) who are parents of any of a plurality of pupils/students attending the school.

In the present embodiment, the first parent-side terminal 31 is a smartphone, the second parent-side terminal 32 is a mobile phone, and the third parent-side terminal 33 is a fixed telephone capable of using touch tone communication.

It should be noted that the terminals for transmitting and receiving information to and from the contact/information sharing assistance system for school of the present invention are not limited to the above. In addition to a laptop computer and a tablet terminal, a smart speaker and the like having a voice reading function of reading information received by email or the like or a voice input function may be adopted.

The server 1 and the school-side terminal 2, and the server 1 and each of the parent-side terminals 3 are configured to be capable of mutually communicating information via an Internet line or the like.

It should be noted that the management system S in the present embodiment executes processing in a plurality of educational institutions by the server 1 owned by the service provider outside of the school. Therefore, the server 1 and the school-side terminal 2 are terminals independent to each other.

However, the contact/information sharing assistance system for school of the present invention is not limited to such a structure. For example, when the contact/information sharing assistance system for school of the present invention is applied to only one educational institution, the server may be omitted by having the school-side terminal also function as the server. In addition, in the present embodiment, only one school-side terminal is used, but a plurality of terminals arranged in the school may be used as the school-side terminals.

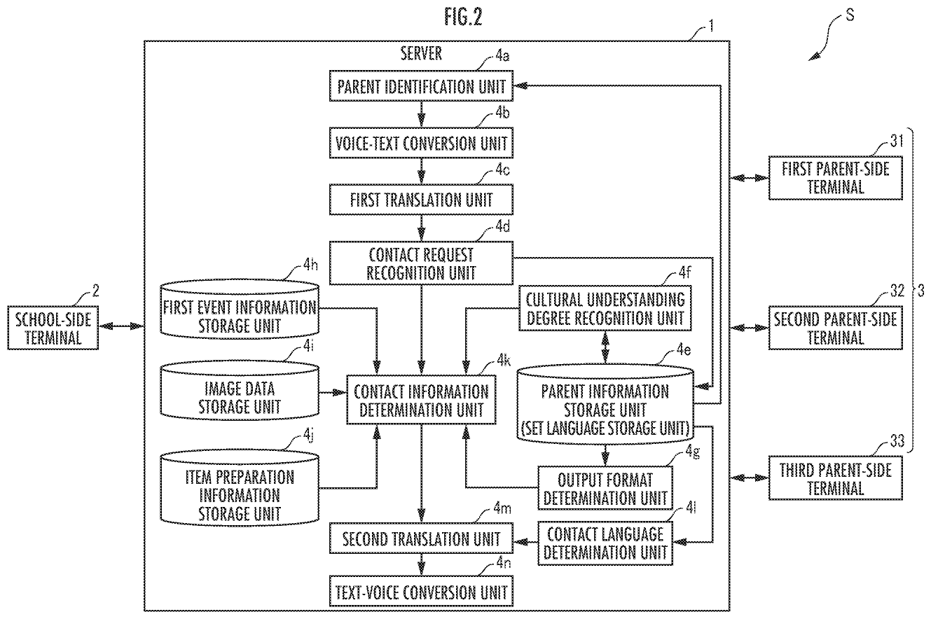

As shown in FIG. 2, the server 1 is provided with, as functions (processing units) implemented by an installed hardware configuration or program, a parent identification unit 4a, a voice-text conversion unit 4b, a first translation unit 4c, a contact request recognition unit 4d, a parent information storage unit 4e (set language storage unit), a cultural understanding degree recognition unit 4f, an output format determination unit 4g, a first event information storage unit 4h, an image data storage unit 4i, an item preparation information storage unit 4j, a contact information determination unit 4k, a contact language determination unit 4l, a second translation unit 4m, and a text-voice conversion unit 4n.

When a contact is received from any one of the parents P, the parent identification unit 4a identifies which parent is the parent P who is a contact destination, based on information stored in the parent information storage unit 4e described later (for example, respective telephone numbers of the parent terminals P).

It should be noted that, as the method of identifying which parent is the parent P who is a contact destination, not only a method of using the information stored in the parent information storage unit 4e, but also a method of identifying the parent based on a signal (for example, a touch-tone signal, a signal related to biometric authentication (authentication by a voice, a fingerprint, a face, or the like), or the like) inputted at the start of the contact via the parent-side terminal 3 used by the parent P who has made the contact, may be used.

The voice-text conversion unit 4b converts a voice inputted by the school teacher via the school-side terminal 2 or a voice inputted by any one of the parents P via any one of the parent-side terminals 3 into text data.

Specifically, when the voice is inputted via the school-side terminal, the inputted voice is recognized as voice data and the voice data is converted into text data in a primarily used language based on the language set when the management system S is installed (Japanese in the present embodiment, which is the language primarily used in the school).

On the other hand, when the voice is inputted via any one of the parent-side terminals 3, the inputted voice is recognized as voice data and the voice data is converted into text data in a set language based on the set language stored in the parent information storage unit 4e described later.

In the first translation unit 4c, when the language of the text data converted by the voice-text conversion unit 4b or the text data recognized after being directly inputted to the school-side terminal 2 or the parent-side terminal 3 is the language other than the language primarily used in the school, the text data is converted into text data in the language primarily used in the school.

The contact request recognition unit 4d recognizes a contact-related request made by the school teacher or the parent P based on at least one of the text data recognized by the voice-text conversion unit 4b, the text data translated by the first translation unit 4c, the data inputted by the school teacher via an input unit such as a keyboard of the school-side terminal 2, and the data inputted by any one of the parents P via an input unit such as a touch panel of the parent-side terminal 3.

In this regard, the contact-related request includes a request related to contact for absence (for example, a date and time, a reason, and the like), a request related to contact for school activities (events) such as an examination, a parent-teacher meeting, a parents' day, and a school athletic meet (for example, the content and the schedule thereof, confirmation of participation, notification or confirmation of a tool (an item) to be used in the event), or the like.

The parent information storage unit 4e (set language storage unit) stores information set for each of the parents P (parent information). In addition, the stored information is updated not only when the school teacher or the parent himself/herself inputs the information but also when the contact is made with the management system S.

Examples of the information set for each of the parents P include a content of a past inquiry, a time of a day when the parent stays at home, and a content of school life of a pupil/student under care of the parent (for example, an item that was not able to be prepared in the past event), in addition to matters such as a set language that is a language set to be used for contact, a desired contact method, a type of the parent-side terminal 3 to be used and information thereof (for example, a telephone number or the like), a relationship with the pupil/student under the care of the parent, a country of origin, a period of residence in the location of the school (in this embodiment, Japan), and a practiced religion.

Based on the information on the parent P stored in the parent information storage unit 4e, the cultural understanding degree recognition unit 4f recognizes a cultural understanding degree that indicates a degree of the parent's understanding with respect to a culture in the location of the school (in this embodiment, Japan).

In this regard, the information on the parent P used when the cultural understanding degree is recognized includes, for example, at least one of a set language for the parent, a country or a region before moving in a country or a region where the school is located (in this embodiment, Japan), a date of moving in/out of Japan, and a period of residence in Japan.

As the cultural understanding degree, for example, a rank or the like is used that is allocated based on the total value of scores obtained by scoring each piece of the information on the parent P. Specifically, for example, when the set language is a language that is often used in Japan, the higher score is given if the period of residence is long or if the item has been successfully prepared in the past contact. As a result, the higher rank is also allocated for the cultural understanding degree.

It should be noted that the method of recognizing the cultural understanding degree in the present invention is not limited to the above. Any method may be used as long as the cultural understanding degree is recognized based on at least one of the pupil/student information and the parent information, which may be arbitrarily set by a system designer. For example, the score itself may be used as the cultural understanding degree without classification in accordance with rank. In addition, items to be scored may be set as appropriate.

The output format determination unit 4g determines an output format for making contact with the parent P based on the content of the contact-related request recognized by the contact request recognition unit 4d, the cultural understanding degree recognized by the cultural understanding degree recognition unit 4f, the information on the parent P stored in the parent information storage unit 4e (for example, the type of a terminal used by the parent P, the time of the day when the parent stays at home, and the like), and the content of the contact information described later that is determined by the contact information determination unit 4k.

Specifically, for example, when contact is made with the first parent P1, since the first parent-side terminal 31 to be used is a smartphone, voice data or text data including image data that can be received by the first parent-side terminal 31 is determined as the output format thereof.

In addition, for example, when contact is made with the second parent P2, since the second parent-side terminal 32 to be used is a mobile phone, voice data or text data including only text that can be received by the second parent-side terminal 32 is determined as the output format thereof.

In addition, for example, when contact is made with the third parent P3, since the third parent-side terminal 33 to be used is a fixed telephone, voice data that can be received by the third parent-side terminal 33 is determined as the output format thereof.

In addition, for example, when contact is made with a parent who is other than the parents P and with whom contact using a communication device such as a smartphone, a mobile phone, or a fixed telephone is difficult, a handout to be distributed to the pupil/student under care of the parent or to be sent by post to the parent of the pupil/student, an issuance of a printing number for printing the handout with a printer installed at a convenience store, or the like is determined as the output format thereof.

In addition, the output format includes a timing (time) and a frequency of contact, in addition to the type of data used for contact (for example, whether it is voice data or text data).

The first event information storage unit 4h stores information (hereinafter, referred to as “first event information”) on matters that require contact and confirmation in relation to various events. Specifically, when the event is an absence of a pupil/student, examples of such matters include matters to be confirmed such as a date and time of the absence and a reason therefor, and matters to be communicated that are generated as the result of the absence (for example, a date and time of a makeup examination when an examination is scheduled on the date and time of the absence). In addition, when the event is a school activity, examples of such matters include a content and a schedule of the school activity, and a tool (an item) to be used in the event.

The image data storage unit 4i stores image data relating to the first event information stored in the first event information storage unit 4h. Specifically, as the image data, item image data that is image data of a tool (an item) to be used in an event held by the school is stored, for example.

In this regard, the “item image data” includes data of the URL of a website related to an image or an explainer video of the item, in addition to data of the image of the item itself.

The item preparation information storage unit 4j stores information on matters necessary for the parent P to prepare an item related to the first event information stored in the first event information storage unit 4h. Specifically, examples of the information include information of a detailed description of the item (for example, the URL or the like of a website that describes the item), a store that sells the item, a price thereof, and the like.

The contact information determination unit 4k determines the contact information that is the information to be communicated to the parent P or the school teacher in response to the request recognized by the contact request recognition unit 4d (that is, the request from the school teacher or the parent P). When the contact information is determined, the output format determined by the output format determination unit 4g and the cultural understanding degree recognized by the cultural understanding degree recognition unit 4f are also referred to.

In addition, the contact information may include, as needed, item information that is information on an item to be used in the event held by the school, the item image data that is the image data of the item recognized after acquired from the image data storage unit 4i, item preparation information that is information related to preparation of the item recognized after acquired from the item preparation information storage unit 4j, in addition to the text data relating to the event recognized after acquired from the first event information storage unit 4h.

The contact language determination unit 4l determines a language to be used when the contact information is transmitted to the parent P, based on the set language stored in the parent information storage unit 4e. It should be noted that the language to be used does not necessarily have to be one type, and a plurality of types of languages may be used.

The second translation unit 4m translates a text portion of the contact information data outputted from the contact information determination unit 4k into text data in the set language of the parent P who is a contact destination when the set language of the parent P is a language other than the language primarily used in the school.

The text-voice conversion unit 4n converts a text portion of the contact information data into voice data when the output format determined by the output format determination unit 4g is voice.

In the server 1, these processing units execute processing relating to assistance for contact for absence from each parent P and contact from the school to any or all of the parents P.

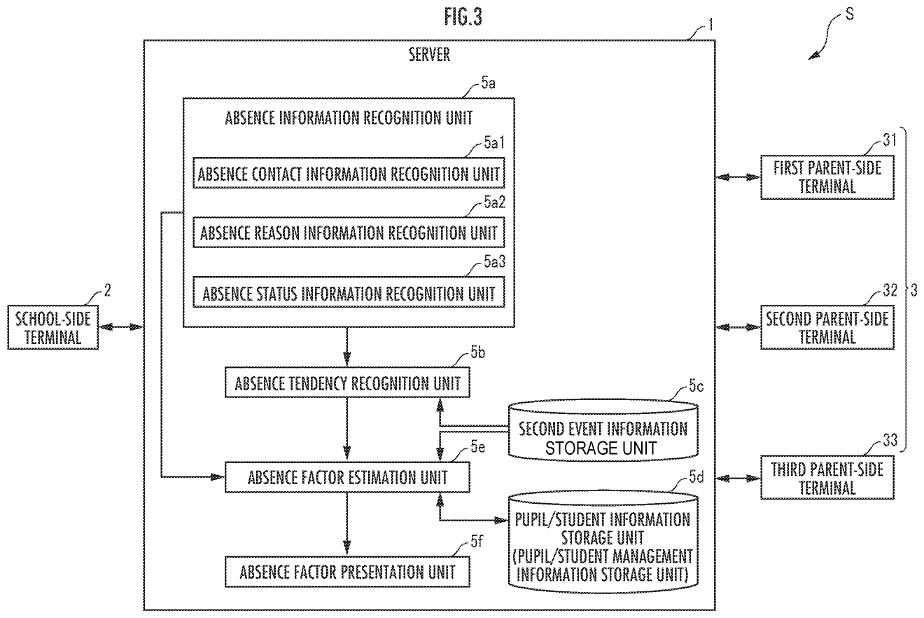

In addition, as shown in FIG. 3, as functions (processing units) implemented by an installed hardware configuration or program, the server 1 has an absence information recognition unit 5a, an absence tendency recognition unit 5b, a second event information storage unit 5c (school event information recognition unit), a pupil/student information storage unit 5d (pupil/student management information storage unit), an absence factor estimation unit 5e, and an absence factor presentation unit 5f.

The absence information recognition unit 5a recognizes absence information that is information on the absence of the pupil/student based on the information inputted by the parent P via the parent-side terminal 3 and the information inputted by the school teacher via the school-side terminal 2 by using the functions of the management system S to assist contact.

In this regard, the “absence” includes absence until a certain time (that is, being late), absence from a certain time (that is, early leaving), and absence for a specific class, in addition to all-day absence.

The absence information recognition unit 5a has an absence contact information recognition unit 5a1, an absence reason information recognition unit 5a2, and an absence status information recognition unit 5a3.

The absence contact information recognition unit 5a1 recognizes absence contact information that is information on contact for absence of the pupil/student. The absence reason information recognition unit 5a2 recognizes absence reason information that is information on a reason for the absence of the pupil/student.

Specifically, from the contact-related request recognized by the contact request recognition unit 4d (see FIG. 2) of the processing units for implementing the functions of the management system S to assist contact, the absence contact information recognition unit 5a1 recognizes a date and time when the pupil/student is absent and a date and time when the contact was made, and the absence reason information recognition unit 5a2 recognizes the reason for the absence communicated as the absence reason information.

The absence status information recognition unit 5a3 recognizes absence status information that indicates whether or not the pupil/student is actually absent. Specifically, after the school teacher inputs, via the school-side terminal 2, the result of confirmation of absence made before the start of a class or the like, the absence status information recognition unit 5a3 recognizes the absence status information based on the inputted information.

The absence tendency recognition unit 5b recognizes an absence tendency that is a tendency of absence of the pupil/student based on the absence information and the second event information described later.

In this regard, the “absence tendency” includes a tendency based on the relationship between the day of absence and the day when a specific event has taken place, in addition to a tendency of the day of absence itself. For example, in addition to simply days of absence and a frequency of successive absences, the absence tendency includes the relationship between the date of a school activity (event) such as an examination or a school athletic meet and the day when the absence contact was made, the relationship between the day when the pupil/student under consideration was absent and the day when another pupil/student who is a friend of the pupil/student under consideration was absent, and the relationship between the day of absence and the day when the pupil/student visited a nurse's office at school.

The second event information storage unit 5c recognizes school event information (hereinafter, referred to as “second event information”) that is information on at least one of a class, an activity, and a club activity in which the pupil/student is to participate. Examples of the second event information include the content, the schedule, and the like of the class, the activity, or the club activity.

The pupil/student information storage unit 5d stores the pupil/student information that is the information set for each of the pupils/students. Examples of the pupil/student information include information on the parent of whom the pupil/student is under care, an absence factor estimated in the past for the pupil/student, and the like, in addition to the matters such as past absence information, academic results, and friendship.

In addition, the pupil/student information includes pupil/student management information. The pupil/student management information is information on at least one of a record of a medical checkup that the pupil/student has taken at the time of enrollment, a school nurse's diary, a description in a health notebook, a guidance outline, and a school affairs record.

In this regard, specifically, the “school affairs record” includes, for example, not only registered records of a year of enrollment, a destination and a date at the time of moving in or out of the school or advancing to a higher educational institution, a semester system, an annual school activity schedule, and the like, but also information to be managed on a school guidance plan or class hours, a student guidance record, learning record information, a health observation record, and the like.

The absence factor estimation unit 5e estimates the absence factor that is the factor affecting the absence of the pupil/student, based on the absence tendency, the absence reason information, the absence contact information, the absence status information, the second event information, and the pupil/student information.

In this regard, the “absence factor” refers to a matter that is a cause of an absence. Examples of the absence factors include causes resulting from school life such as a specific class or school activity, a relationship between the pupil/student under consideration and his or her friend or teacher, poor academic performance, maladaptation in a club activity, a problem over the school rule or the code of conduct at school, maladaptation at the time of enrollment, transfer to the school or from another school, and advancement to the next grade.

In addition, examples of the absence factors also include causes resulting from the student/pupil or the family thereof, such as health of the pupil/student under consideration, a rapid change in the family environment, a problem over the parent-child relationship, and domestic disagreement.

Further, the absence factors include not only the causes resulting from school life and the causes resulting from the pupil/student or the family thereof as described above, but also situations caused by these causes (for example, bullying, refusal to attend school, suspected depression, and the like).

A method of estimating the absence factor from the absence tendency includes, for example, a method of estimation by simply using the reason of absence as the absence factor when the number of days of absence due to a given reason of absence exceeds a given number of days.

In addition, the method of estimating the absence factor includes, for example, a method of estimating an absence factor in the family environment of the pupil/student by referring to the student/pupil information when there is a difference between the day when the contact for absence was made and the day when the pupil/student was actually absent.

In addition, the method of estimating the absence factor includes, for example, a method of simply plotting the days when the pupil/student was absent, using the absence pattern as an absence tendency, and then estimating, when the absence tendency corresponds to a predetermined pattern, the absence factor corresponding to the predetermined pattern as the absence factor of the pupil/student.

In addition, the method of estimating the absence factor includes, for example, a method of comparing the date and time when the absence tendency has changed with the date and time of any event related to the school, and then estimating the event as the absence factor when the absence tendency has changes on the basis of the date and time of the event.

The absence factor presentation unit 5f makes a presentation to the school teacher via the school-side terminal 2 when the absence factor estimated by the absence factor estimation unit 5e is a predetermined absence factor.

In the server 1, these processing units execute processing relating to assistance for a life guidance work to the pupil/student (for example, a work related to a learning environment or a school life environment, a mental and physical health problem, or health management).

It should be noted that the structure described with reference to FIGS. 2 and 3 is an example of the contact/information sharing assistance system for school of the present invention. In other words, the functions (processing units) implemented by a hardware configuration or program installed in the server 1 in the present embodiment do not necessarily have to be implemented by a single server.

For example, the functions may be implemented by using hardware configurations or programs installed in a plurality of servers, or may be implemented in cooperation with a hardware configuration or a program installed in at least one of the school-side terminal and the parent-side terminal, in addition to the hardware configuration or the program installed in the server. In addition, the functions may be implemented by using a hardware configuration or a program installed in at least one of the school-side terminal and the parent-side terminal without using the server.

Next, with reference to FIGS. 2 to 9, processing executed by the server 1 of the management system S will be described.

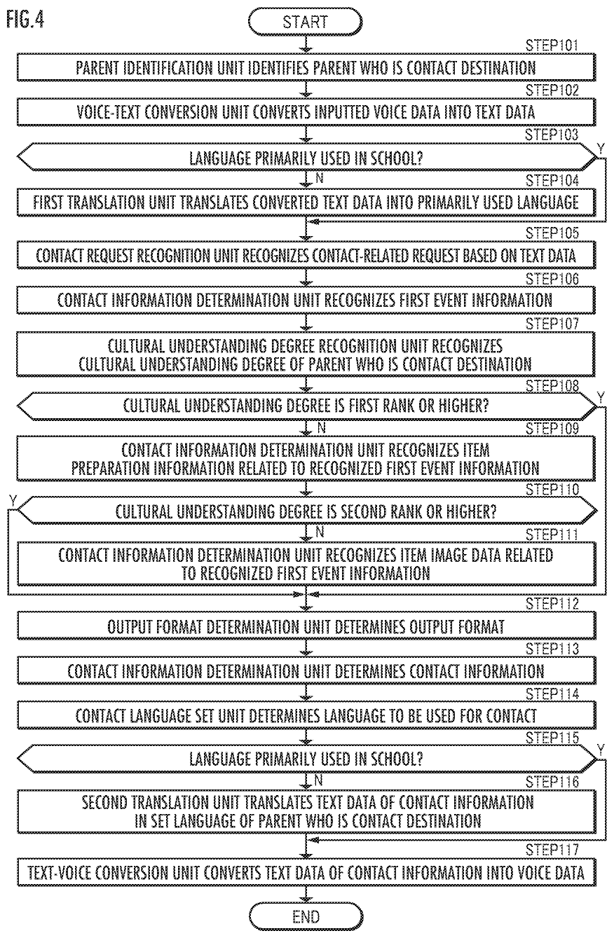

First, with reference to FIGS. 2 and 4, processing executed when contact is made between the parent P and the school teacher by using the management system S will be described. Specifically, processing executed when one of the parents P makes an inquiry to the school teacher about an event to be held by the school will be described.

In this processing, first, the parent identification unit 4a identifies the parent P who has made the contact (that is, the parent P who is a contact destination) based on the information of the parent-side terminal 3 that has accessed the server 1 and the information stored in the parent information storage unit 4e (for example, a telephone number or the like) (FIG. 4/STEP101).

At this time, the server 1 recognizes the set language of the parent P who is a contact destination and the information of the desired contact method. Then, the server 1 execute processing for recognizing a contact-related request based on the recognized information.

Specifically, if a verbal conversation is desired as the contact method, the server 1 sends a message such as “please leave a message” to the parent-side terminal 3 from which the contact has been made, and the contact-related request from the parent P who is a contact destination is recognized after the processing from STEP102 to STEP105 described later is executed.

On the other hand, if a contact method using a touch-tone signal is desired as the contact method, the server 1 sends a given message in the set language and recognizes the touch-tone signal in response to the transmission, instead of the processing from STEP102 to STEP105, thereby recognizing the contact-related request from the parent P who is a contact destination.

The given message is, for example, a message such as “please press 1 for contact for absence, press 2 for an inquiry about school activities, and press 3 for other inquiries.”

When the cultural understanding degree of the parent P who is a contact destination is stored in the parent information storage unit 4e, the given message may be determined also by referring to the cultural understanding degree. Specifically, the text is preferably concise if the cultural understanding degree is high, and the text is preferably simple but can be long if the cultural understanding degree is low.

Alternatively, the processing in STEP101 may be omitted, and all the parents P may be uniformly recognized by voice or by a touch-tone signal.

Next, the voice-text conversion unit 4b recognizes voice inputted via any one of the parent-side terminals 3 used by any one of the parents P as voice data, and then converts the voice data into text data in the set language of the parent P (FIG. 4/STEP102).

Next, the first translation unit 4c determines whether or not the language used in the converted text data is the language primarily used in the school (FIG. 4/STEP103).

If it is determined that the language is not the primarily used language (NO in STEP103), the first translation unit 4c translates the converted text data into text data in the primarily used language (FIG. 4/STEP104).

On the other hand, if it is determined that the language is the primarily used language (YES in STEP103), or if the processing of translating the text data into the text data in the primarily used language is executed, the contact request recognition unit 4d recognizes a contact-related request by the parent P based on the recognized text data or the translated text data (FIG. 4/STEP105).

Next, the contact information determination unit 4k recognizes the first event information on the event related to the request after acquiring it from the first event information storage unit 4h based on the contact-related request by the parent P (FIG. 4/STEP106).

Next, the cultural understanding degree recognition unit 4f acquires, from the parent information storage unit 4e, information on the parent P who is a contact destination and then recognizes the cultural understanding degree of the parent P based on the information (FIG. 4/STEP107).

Specifically, scoring is performed for each piece of information on the parent P, the total value of the resulting scores is set as the cultural understanding degree of the parent P, and one of the preset ranks is allocated based on the score thereof.

Examples of the preset ranks include a first rank (native-like understanding and no obstacle to school life), a second rank (understanding of the language only, frequently absent from a school activity, a parents' open day, a meeting, and the like, and frequently forgetting to bring required items to school), a third rank (insufficient understanding of even the language, an interpreter required to communicate with a school teacher), and the like.

It should be noted that when the cultural understanding degree is recognized, not only the parent information but also the pupil/student information stored in the pupil/student information storage unit 5d may be referred to. Alternatively, only the pupil/student information may be referred to without referring to the parent information.

In addition, when the cultural understanding degree of the parent P who is a contact destination has been recognized at the time of the inquiry or the like made prior to the current inquiry, and the cultural understanding degree of the parent P has been stored in the parent information storage unit 4e, instead of calculating the cultural understanding degree thereof again, the processing in STEP107 may be omitted and the stored cultural understanding degree may be acquired and recognized.

Next, the contact information determination unit 4k determines whether or not the recognized cultural understanding degree is equal to or higher than the first rank (native-level ability to understand) (FIG. 4/STEP108).

When it is determined that the cultural understanding degree is below the first rank (that is, the second rank (sufficiently understanding the language only) or the third rank (insufficient understanding even of the language) (NO in STEP108), the contact information determination unit 4k acquires, from the item preparation information storage unit 4j, the item preparation information on the item related to the recognized first event information, and then recognizes the item preparation information (FIG. 4/STEP109).

Specifically, for example, if the recognized event is a school athletic meet and a red-and-white cap is used at the school athletic meet, the contact information determination unit 4k acquires information of a store that sells the red-and-white cap, a price of the red-and-white cap, and the like as the item preparation information, and then recognizes the information.

The item preparation information acquired in this manner is transmitted to the parent P who is a contact destination, as a part of the contact information as described later.

This is because, depending on the cultural understanding degree of the parent P, the parent P may understand the item itself to be used in the event held by the school but may not know how to prepare the item. Therefore, as described above, if the item preparation information is included in the contact information, the parent P can easily prepare the item.

Next, the contact information determination unit 4k determines whether or not the recognized cultural understanding degree is equal to or higher than the second rank (FIG. 4/STEP110).

If it is determined that the cultural understanding degree is below the second rank (that is, it is the third rank (insufficient understanding even of the language)) (NO in STEP110), the contact information determination unit 4k acquires, from the image data storage unit 4i, the item image data on the item related to the recognized first event information and then recognizes the item image data (FIG. 4/STEP111).

Specifically, for example, if the recognized event is a school athletic meet and a red-and-white cap is used at the school athletic meet, the contact information determination unit 4k acquires image data of the red-and-white cap and then recognizes the image data.

The item image data acquired in this manner is transmitted to the parent P who is a contact destination, as a part of the contact information as described later.

This is because, depending on the cultural understanding degree of the parent P, the parent P may not have a sufficient mastery even of the set language, and thus may not be able to understand the item itself to be used in the event held by the school. Therefore, as described above, if the item image data is included in the contact information, the parent P can also fully understand the content of the contact information even if the parent P does not have a sufficient mastery of the set language.

On the other hand, if it is determined that the cultural understanding degree is equal to or higher than the first rank (YES in STEP108), if it is determined that the cultural understanding degree is equal to or higher than the second rank (YES in STEP110), or if the processing of recognizing the item image data is executed, the output format determination unit 4g determines the output format for the parent P who is a contact destination (FIG. 4/STEP112).

Specifically, the output format determination unit 4g determines the output format for the parent P who is a contact destination, based on the content of the contact-related request recognized by the contact request recognition unit 4d, the parent information recognized after being acquired from the parent information storage unit 4e (for example, the type of a terminal used by the parent P, the time of a day when the parent P stays home, and the like), the cultural understanding degree recognized by the cultural understanding degree recognition unit 4f (for example, when the rank of the cultural understanding degree is low, the frequency of contact is increased and/or a plurality of types of contact methods are prepared), and the content of the contact information determined by the contact information determination unit 4k (specifically, whether or not the item preparation information or the item image data is included in the contact information).

The output format to be determined includes a contact destination (whether at home or at work, or the like.), a timing (time) and a frequency of contact, and the like, in addition to a type of data used for contact (for example, whether it is voice data or text data).

Next, the contact information determination unit 4k determines the contact information to be communicated to the parent P who is a contact destination, based on the recognized first event information, the item preparation information, the item image data, and the output format (FIG. 4/STEP113).

The contact information to be determined includes the image recognized after being acquired from the image data storage unit 4i and the item information related to the preparation of the item recognized after being acquired from the item preparation information storage unit 4j, both in accordance with the results of the processing up to this point, in addition to the text data relating to the event recognized after being acquired from the first event information storage unit 4h. In addition, a text of the text data may be changed in accordance with the output format (specifically, the contact destination, the frequency and the time of transmission, and the like).

Next, the contact language determination unit 4l determines the language to be used when the contact information is transmitted to the parent P who is a contact destination, based on the set language stored in the parent information storage unit 4e (FIG. 4/STEP114).

Next, the second translation unit 4m determines whether or not the set language of the parent P who is a contact destination is the language primarily used in the school (FIG. 4/STEP115).

If it is determined that the language is not the primarily used language (NO in STEP115), the second translation unit 4m translates text data included in the contact information into text data in the set language of the parent P who is a contact destination (FIG. 4/STEP116).

On the other hand, if it is determined that the language is the primarily used language (YES in STEP115) or if the processing of translating the text data into the text data in the primarily used language is executed, the text-voice conversion unit 4n converts the text data included in the contact information or the translated text data into voice data to end the processing (FIG. 4/STEP117).

The contact information and the voice data thereof determined in this manner are transmitted from the server 1 to the parent-side terminal 3 of the parent P who is a contact destination. In addition, if the contact-related request is based on the inquiry from the parent P, this fact (which leads to the fact that the parent P was not able to understand the contact to the extent that necessitates the inquiry to be made) is stored in the parent information storage unit 4e.

As described above, in the management system S, the content of the contact information transmitted to the parent P is changed in accordance with the cultural understanding degree of the parent P. As a result, even if the cultural understanding degree of the parent P who is a contact destination is low (for example, the parent P does not have a sufficient mastery of the primary language used in the school), the parent P can fully understand the content of the contact information (that is, the content of the contact).

It should be noted that in the description with reference to the flowchart of FIG. 4 described above, the processing executed when any one of the parents P makes an inquiry to the school teacher about the event to be held by the school has been described.

On the other hand, when the teacher transmits contact on an event to be held by the school simultaneously to each of the parents P, the processing of STEP102 to STEP104 in FIG. 4 are omitted, and in STEP101 and STEP105, the parent identification unit 4a and the contact request recognition unit 4d recognize the parent P who is a contact destination and the contact-related request, based on the data inputted to the school-side terminal 2 by the school teacher.

However, when the school teacher uses a language other than the primarily used language and the set language for the school teacher has been set, STEP102 to STEP104 are not omitted, and the same processing as the above description is executed.

In addition, in the above description, it is determined whether or not the item image data and the item preparation information are included in the contact information as the item information in accordance with the cultural understanding degree of the parent P who is a contact destination. This is because, depending on the cultural understanding degree of the parent, not only the item image data and the item preparation information may be unnecessary, but also the contact content may be easier to understand without such information.

However, the contact/information sharing assistance system for school of the present invention is not limited to such a structure. For example, at least one of the item image data and the item preparation information may be included in the contact information regardless of the cultural understanding degree. In that case, the cultural understanding degree need not be determined.

Further, in the above description, the processing of converting the text data included in the determined contact information into voice data is executed. However, the contact/information sharing assistance system for school of the present invention is not limited to such a structure.

For example, when the parent-side terminal of the parent who is a contact destination can only receive an email, the text data included in the contact information may not be converted into voice data. In addition, for example, when the method of making contact with the parent who is a contact destination is distribution or posting of a handout, the processing of transmitting data relating to the contact information (that is, data for printing) to the school-side terminal may be executed, instead of performing the conversion.

Next, with reference to FIG. 3 and FIGS. 5 to 9, processing executed when the status of a pupil/student is grasped by using the management system S will be described.

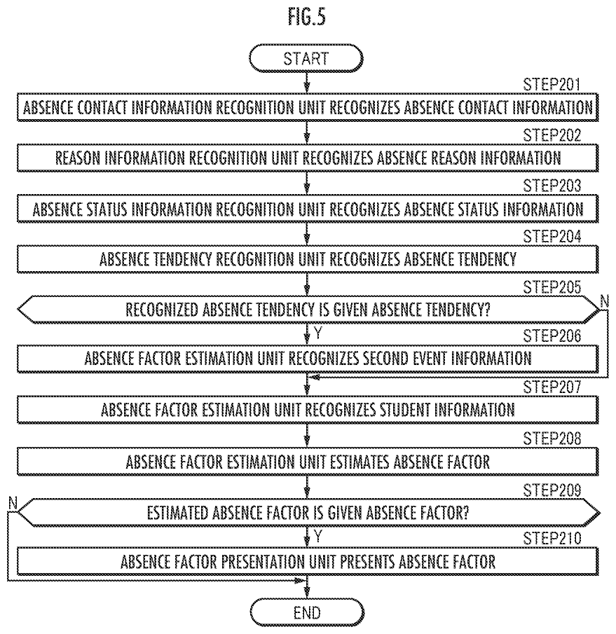

In this processing, first, the absence contact information recognition unit 5a1 of the absence information recognition unit 5a recognizes, as the absence contact information, the date and time when the pupil/student is absent and the date and time when the contact was made, from the contact-related request recognized by the contact request recognition unit 4d (see FIG. 2) of the processing units for implementing the functions of the management system S to assist contact (FIG. 5/STEP201).

Next, the absence reason information recognition unit 5a2 of the absence information recognition unit 5a recognizes the reason for absence as the absence reason information, from the contact-related request recognized by the contact request recognition unit 4d, in a similar manner as the recognition of the absence contact information (FIG. 5/STEP202).

The processing of STEP201 and STEP202 is executed at any time when a contact from the parent P is received until the class from which the pupil/student is absent is started. As a result, the absence contact information and the absence reason information for each pupil/student are accumulated.

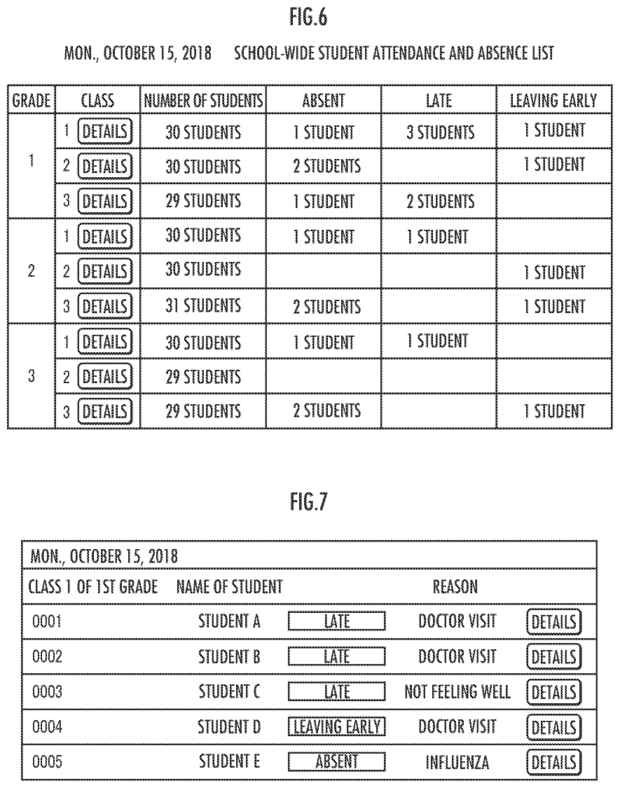

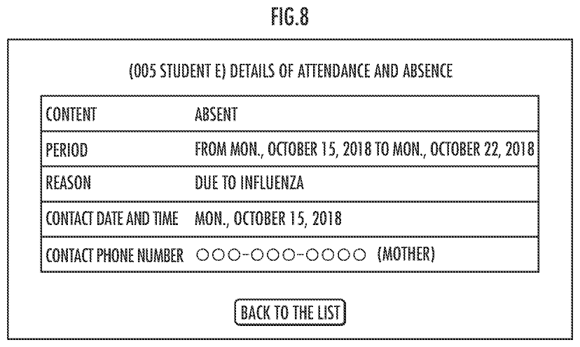

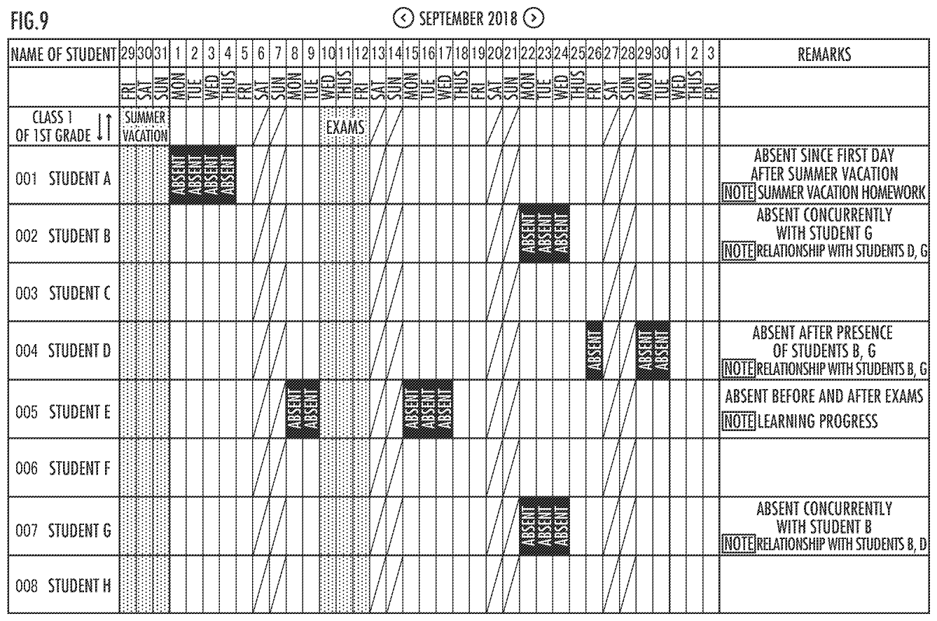

Then, in the management system S, at the stage before the class or the like from which the pupil/student is absent is started, it is possible to display, via the school-side terminal 2, a list showing a status of absence for each school as shown in FIG. 6, a list showing a status of absence for each class as shown in FIG. 7, and detailed information on absence of each pupil/student as shown in FIG. 8, based on the absence contact information that has been accumulated.

Specifically, by selecting any one of a plurality of “details” items on the screen of FIG. 6, the screen of FIG. 7 is displayed for a class relating to the selected “details” item. Similarly, by selecting any one of a plurality of “details” items on the screen of FIG. 7, the screen of FIG. 8 is displayed for an individual student relating to the selected “details” item.

As a result, the school teacher can easily grasp the contact for absence of a multitude of pupils/students and the reasons thereof, without performing a complicated confirmation work.

Next, the absence status information recognition unit 5a3 of the absence information recognition unit 5a recognizes the absence status information based on the information inputted by the school teacher via the school-side terminal 2 regarding the result of confirmation of absence that has been made before the start of a class or the like (FIG. 5/STEP203).

Next, the absence tendency recognition unit 5b recognizes the absence tendency for each pupil/student based on the recognized absence information and the second event information (FIG. 5/STEP204).

Specifically, as in the screen shown in FIG. 9, the absence tendency recognition unit 5b first plots an absent day of each pupil/student based on the absence information, and then plots school activities such as a summer vacation and an examination based on the second event information. Then, the result of the plotting (that is, the pattern of absence) is recognized as the absence tendency of the pupil/student.

For example, as shown in the upper part of the column of the item titled remarks in the image diagram shown in FIG. 9, absence tendencies are recognized such as absence since the first day after a summer vacation for a pupil/student A, absence at the same time as or at a different time from other pupils/students for pupils/students B, D, and G, and absence before and/or after an examination for a pupil/student E.

It should be noted that at the time of recognizing the absence tendency, the absence tendency may be recognized based on whether or not an absence pattern, which is recognized by referring to a pattern table showing the relationship between an absence pattern and the absence tendency determined in advance by a system designer or the like, corresponds to any one of patterns that are described in the pattern table. Alternatively, the absence tendency may be recognized based on a given algorithm in which the absence pattern is an input item and the absence tendency is an output item.

Next, the absence factor estimation unit 5e determines whether or not the absence tendency recognized for each pupil/student is a given absence tendency that needs to be considered (for example, absent for a given number of days or more in succession, absent for 30 days or more in a year, or the like) (FIG. 5/STEP205).

If none of the absence tendencies recognized for all pupils/students is the given absence tendency (NO in STEP205), the management system S ends the processing.

On the other hand, if the absence tendency recognized for any of the pupils/students is the given absence tendency (YES in STEP205), the absence factor estimation unit 5e acquires the second event information from the second event information storage unit 5c and recognizes the second event information (FIG. 5/STEP206).

Next, the absence factor estimation unit 5e acquires, from the pupil/student information storage unit 5d, pupil/student information of a pupil/student relating to the absence tendency that has been determined to correspond to the given absence tendency, and then recognizes the pupil/student information (FIG. 5/STEP207).

Next, the absence factor estimation unit 5e estimates an absence factor of the pupil/student relating to the absence tendency that has been determined to correspond to the given absence tendency, based on the absence tendency, the absence reason information, the absence contact information, the absence status information, the second event information, and the pupil/student information (FIG. 5/STEP208).

Specifically, for example, the absence factor estimation unit 5e firsts refers to a pattern table showing the relationship between an absence tendency and a type of an absence factor determined in advance by a system designer or the like, acquires the type of an absence factor for the recognized absence tendency, and then recognizes the type of an absence factor. After that, the absence factor estimation unit 5e estimates a specific absence factor by referring to the school event and the friendship of the pupil/student that are estimated to be related to the absence tendency, the reason given at the time of the contact for absence, whether or not the pupil/student was actually absent (in other words, the result of a comparison between the absence contact information and the absence status information), and a past absence factor of the pupil/student.

In addition, the method of estimating the absence factor is not limited to such a method. Any method may be used as long as the absence factor is estimated based on the absence tendency. For example, the absence factor itself may be recognized based on an absence tendency that is recognized by referring to a predetermined pattern table showing a relationship between the absence tendency and the absence factor itself.

In addition, for example, the absence factor may be estimated based on a given algorithm in which the absence tendency, or at least one of the absence tendency, the absence reason information, the absence contact information, the absence status information, the second event information, and the pupil/student information is an input item, and the absence factor itself or the type of the absent factor is an output item.

Next, the absence factor estimation unit 5e determines whether or not the absence factor estimated for each pupil/student is the given absence factor that needs a special student guidance work such as care for a learning environment, a school life environment, and a physical and/or mental health condition of the pupil/student (for example, bullying, a deviation between the progress of the class and the progress of the learning, and the like) (FIG. 5/STEP209).

Specifically, for example, the absence factor estimation unit 5e determines whether or not the estimated absence factor corresponds, once or a given number of times or more, to the given absence factor determined in advance by a system designer or the like.

If none of the absence factors estimated for all pupils/students is the given absence factor (NO in STEP209), the management system S ends the processing.

On the other hand, if the absence factor estimated for any of the pupils/students is the given absence factor (YES in STEP209), the absence factor presentation unit 5f presents the absence factor to the school teacher via the school-side terminal 2 and ends the processing (FIG. 5/STEP210).

Specifically, for example, as shown in the lower part of the column of the item titled remarks in the image diagram shown in FIG. 9, matters are presented as the absence factors, such as summer vacation homework for a pupil/student A, relationship with other pupils/students for pupils/students B, D, and G, and progress of learning for a pupil/student E.

It should be noted that the absence factor estimated in this manner is stored in the pupil/student information storage unit 5d to be used when the absence factor is estimated in the next and succeeding processing.

As described above, the management system S is configured such that, based on the information on absence of a pupil/student (the absence tendency), it is estimated and presented whether a matter (an absence factor) that causes the pupil/student to be absent is a general matter such as an illness, or a special matter that needs a student guidance work such as care for a learning environment, a school life environment, and a mental and/or physical health condition of the pupil/student.

Therefore, according to the management system S, since the matter that causes an absence is estimated based on the information of absence that can be easily gathered, even if the school teacher is inexperienced or the number of pupils/students is large, by using the result of estimation, the teacher can not only easily grasp whether or not the student guidance work is necessary but also perform the work appropriately.

It should be noted that in the description with reference to the flowchart of FIG. 5 described above, at the time of estimating the absence factor, the absence factor estimation unit 5e refers to not only the absence tendency but also the absence reason information, the absence contact information, the absence status information, the second event information, and the pupil/student information.

This is because the second event information (school event information), which is information related to at least one of the reason for absence, a difference between the contact for absence and the actual absence status, the class, the event, and the club activity in which the pupil/student is to participate, has a significant impact on the cause of absence of the pupil/student.

However, the contact/information sharing assistance system for school of the present invention is not limited to such a structure, and may be any structure that refers to at least the absence tendency at the time of estimating the absence factor. For example, any one of the absence reason information, the absence contact information, the absence status information, the second event information, and the pupil/student information may not be referred to.

### REFERENCE SIGNS LIST

1 server
2 school-side terminal
3 parent-side terminal
4a parent identification unit
4b voice-text conversion unit
4c first translation unit
4d contact request recognition unit
4e parent information storage unit (set language storage unit)
4f cultural understanding degree recognition unit
4g output format determination unit
4h first event information storage unit
4i image data storage unit
4j item preparation information storage unit
4k contact information determination unit
4l contact language determination unit
4m second translation unit
4n text-voice conversion unit
5a absence information recognition unit
5a1 absence contact information recognition unit
5a2 absence reason information recognition unit
5a3 absence status information recognition unit
5b absence tendency recognition unit
5c second event information storage unit (school event information recognition unit)
5d pupil/student information storage unit (pupil/student management information storage unit)
5e absence factor estimation unit
5f absence factor presentation unit
31 first parent-side terminal
32 second parent-side terminal
33 third parent-side terminal
P parent
P1 first parent
P2 second parent
P3 third parent
S management system (contact/information sharing assistance system for school)

1. A contact/information sharing assistance system for school for assisting contact and information sharing between a school teacher who is a member of staff of a school and each parent of a plurality of pupils/students attending the school, comprising:
a contact information determination unit for determining contact information that is information to be communicated to the parent in response to a request from the school teacher or the parent; and
a cultural understanding degree recognition unit for recognizing a cultural understanding degree that indicates a degree of understanding of the parent with respect to a culture in a location of the school, based on at least one of pupil/student information that is information on the pupil/student and parent information that is information on the parent of the pupil/student, wherein:
the contact information determination unit changes a content of the contact information in accordance with the recognized cultural understanding degree.

2. The contact/information sharing assistance system for school according to claim 1, further comprising:
a set language storage unit for storing a set language that is a language set for each of the parents, wherein:
the cultural understanding degree recognition unit recognizes the cultural understanding degree by referring to at least one of the set language, a country or a region before moving in a country or a region where the school is located, a date of moving in and/or out of the country or the region where the school is located, and a period of residence in the country or the region where the school is located.

3. The contact/information sharing assistance system for school according to claim 1, further comprising:
an output format determination unit for determining an output format of the contact information at a time of contact with the parent, wherein:
the output format determination unit determines the output format by referring to the cultural understanding degree.

4. The contact/information sharing assistance system for school according to claim 1, wherein:
the contact information determination unit causes the contact information to include item image data that is image data of an item to be used in an event held by the school, in accordance with the cultural understanding degree of the parent.

5. The contact/information sharing assistance system for school according to claim 1, wherein:
the contact information determination unit causes the contact information to include item preparation information that is information for preparing an item to be used in an event held by the school, in accordance with the cultural understanding degree of the parent.
